(19) United States
(12) Patent Application Publication
(10) Pub. No.: US 2005/0202828 A1
(43) Pub. Date: Sep. 15, 2005

(54) System and method for determining availability of radio access technology associated with a wireless network

(76) Inventors: Mark E. Pecen, Palatine, IL (US); Niels Peter Skov Andersen, Roskilde (DK); Stephen A. Howell, Gloucester (GB)

Correspondence Address: MOTOROLA INC, 600 NORTH US HIGHWAY 45, ROOM AS437, LIBERTYVILLE, IL, 60048-5343, US

(21) Appl. No.: 10/800,172

(22) Filed: Mar. 12, 2004

(51) Int. Cl. H04B 1/38

(52) U.S. Cl. 455/453

(57) ABSTRACT

A wireless communication device (102), a wireless communication network and methods therefor. The wireless communication device (102) comprises a transceiver (202) configured to receive a neighbor list (216) from a remote source (108, 110, 112). The device (102) receives the neighbor list (216) that includes one or more technology type indicators and determines availability of technology based on the neighbor list. The wireless communication network comprise a server (112) and a base station (108, 110) communicating with the server. The server (112) inserts network identification and technology type to the neighbor list (216), and the base (108, 110) station provides the neighbor list to a remote device (102).

### FIELD OF THE INVENTION

The present invention relates generally to the field of portable electronic device having wireless communication capabilities and, more specifically, to wireless communication devices having the ability to scan for multiple communication links.

### BACKGROUND OF THE INVENTION

A wireless communication system may be divided into separate operational networks that operate, to a large extent, independently of each other. For example, for Global System for Mobile telecommunication (GSM), each operational network is referred to as Public Land Mobile Network (PLMN). Several operational networks may be grouped in a single system by a common communication standard so that a wireless communication device may “roam”, i.e., move from one network to another and continue to receive communication services. A wireless communication device has the capability to roam if the operational networks are capable of communicating between themselves and the device is capable of accessing the different networks.

A wireless communication device may utilize an air interface to access a particular operational network. For example, for Global System for Mobile telecommunication (GSM), the air interface is referred to as a Radio Access Technology (RAT). A given device may change air interfaces when roaming from one operational network to another or when changing protocols within a particular operation network.

When a wireless communication device is in idle mode, i.e. not in dedicated or packet data communication with the network, the device periodically searches around for other appropriate operational networks and air interfaces. Typically, the device performs a generalized “long-scan” sequence during which it searches multiple frequencies for multiple operational networks and multiple air interfaces. Unfortunately, performance of a general long-scan consumes both time and power for a wireless communication device, which may impact scheduling operations of the signalling stack and power consumption.

Therefore, there a need for a wireless communication device that minimizes its performance of general long-scans in order to minimize power consumption

### BRIEF DESCRIPTION OF THE DRAWINGS

FIG. 1 is a system view illustrating an exemplary wireless communication system in accordance with the present invention.

FIG. 2 is a block diagram representing an embodiment of a wireless communication device in accordance with the present invention.

FIG. 3 is a bit map format diagram of a Neighbor Cell Description element.

FIG. 4 is a flow diagram representing an operation of the wireless communication system in accordance with the present invention.

FIG. 5 is a flow diagram representing an operation of the wireless communication device in accordance with the present invention.

FIG. 6 is a flow diagram representing another operation of the wireless communication system in accordance with the present invention.

### DETAILED DESCRIPTION OF THE PREFERRED EMBODIMENTS

The present invention is a wireless communication system and method for utilizing information in possession by a wireless communication device in advance of a requisite scanning operation. In particular, the wireless communication device may use a neighbor list of cells received from a wireless communication network for the purpose of determining the availability of technology types associated with a network on which the device is currently registered or otherwise may be directed to register based on a priority level for a given network. Also, the wireless communication device may use any logical bindings between technology types and networks acquired during a general long-scan operation, thus eliminating the need for periodic long scan operations for the purpose of associating technology types to networks over the duration of mobile terminal operation.

A technology type is a type of radio technology used to access a core network, such as a Radio Access Technology (RAT). Examples of RAT's include, but are not limited to, Universal Mobile Telecommunication system (UMTS), Global System for Mobile telecommunication (GSM), Code Division Multiple Access 2000 (CDMA2000), Wideband Code Division Multiple Access (WCDMA), Digital Enhanced Cordless Technology (DECT), GPRS, EDGE, IEEE 802.11 (such as Wi-Fi), IEEE 802.16 (Bluetooth), and the like.

A network is a wireless communication network used to communicate via land-based radio transmitters or base stations, such as a Public Land Mobile Network (PLMN). A subscriber using a wireless communication device may have a Home network based on a subscription relationship with a particular network. For example, a GSM customer may have a subscription relationship with a PLMN.

A wireless communication device may receive a neighbor list from an operational network, such as a switch via a base station. For example, the neighbor list may be a group of parameters stored in a database of a base station controller (BSC) located in a mobile switching center (MSC). The neighbor list includes a list of all channels that should be considered for use by the wireless communication device at any given area. Thus, the neighbor list includes channels (frequencies) assigned to a site and channels assigned to neighboring cell sites. Each cell of the operational network is associated with a different neighbor list. Each wireless communication device may measure each channel, as directed by the network, and report various information, such as signal strength and other pertinent parameters. The neighbor lists may be downloaded to a BSC and used by the BSC to control device handoffs between adjacent sectors and neighboring cell sites.

One aspect of the present invention is a wireless communication device which comprises a transceiver configured to receive a neighbor list from a remote source. Also, the present invention is a method for a wireless communication device which comprises receiving a neighbor list and determining availability of technology based on the neighbor list. The neighbor list includes one or more technology type indicators.

Another aspect of the present invention is a wireless communication network which comprise a server and a base station communicating with the server. The server inserts network identification and technology type to a neighbor list. The base station provides the neighbor list to a remote device. Also, the present invention is a method for a wireless communication network which comprises inserting network identification and technology type to a neighbor list; and providing the neighbor list to a remote device.

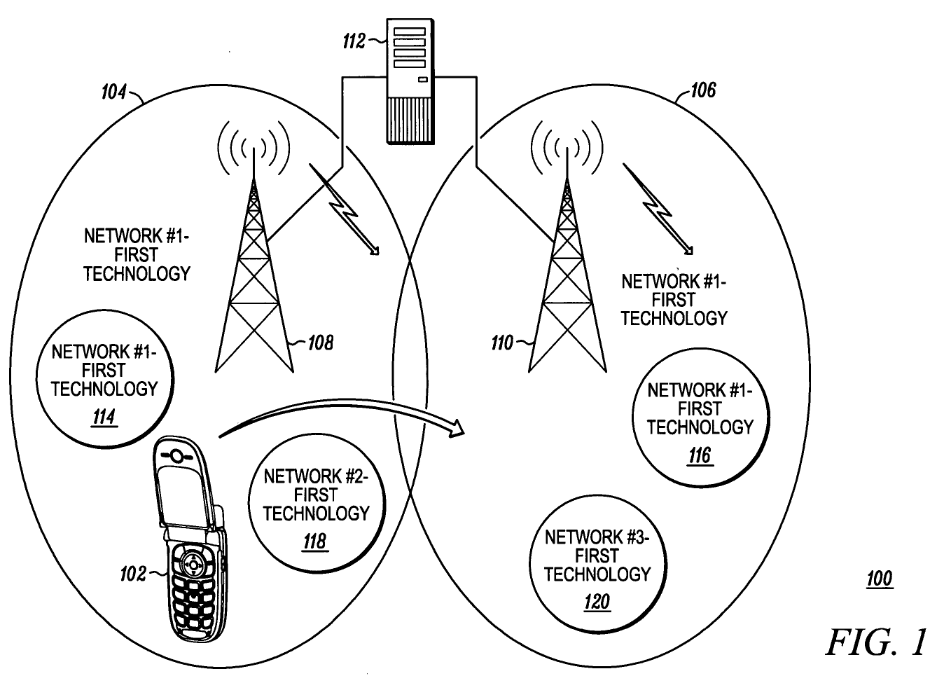

Referring to FIG. 1, there is provided an exemplary environment 100 where some aspects of the present inventions may be practiced. For this exemplary environment, there is a wireless communication device 102 located within one or more regions 104, 106 which may or may not overlap one another. Each region 104, 106 includes at least one base station 108, 110. In particular, a first base station 108 provides communication links with wireless communication devices for a first network for the area covered by the first region 104, and the second base station 110 provides communication links with wireless communication devices for a second network for the area covered by the second region 106. For the embodiment shown in FIG. 1, the first and second regions 104, 106 are part of a single network, i.e., network #1; utilize the same technology type, i.e., first technology; and are connected to a common infrastructure which includes a server 112. However, it is to be understood that the first and second regions 104, 106 may be part of different networks and/or utility different technology within departing from the scope of the present invention. A network may be managed by a single operator or commonly managed by a group of operators, and each network may utility one or more technology types.

In addition, other networks and/or technology types may cover areas that overlap the first and second regions 104, 106. As shown in FIG. 1, network #1 may also utilize a second technology covering areas that overlap coverage of its first technology. For example, a network operated by a particular carrier may utilize GSM radio access technology (RAT) to provide communication coverage for the first and second regions 104, 106, and utilize UMTS RAT to provide communication coverage for a third region 114 within the first region and a fourth region 116 within the second region. In addition, other networks may provide coverage overlapping coverage of the first network. For example, a second network (i.e., network #2) operated by a different carrier may utilize UMTS RAT to provide communication coverage for a fifth region 118 overlapping the first region 104, and a third network (i.e., network #3) operated by yet another carrier may utility UMTS RAT to provide communication coverage for a sixth region 120 overlapping the second region 104.

The wireless communication device 102 may change technology types of the same network, change technology types of different networks, utilize the same technology type of the same network, or change networks while utilizing the same technology type. For example, when the wireless communication device 102 leaves the first region 104 operated by Carrier A, travel through the second region 106, and enters the sixth region 120, it may be necessary for the device to register and operate in the sixth network provided by a different carrier, i.e., Carrier B. A home carrier of the wireless communication device may have different contracts with each of the Carriers A and B, which may affect the fee charged to the wireless communication device, for example when the wireless communication device is roaming. As another example, the wireless communication device 102 may enter the fourth region 116, from the second region 106, and select in a different technology type offered within the fourth region by the same or different network. In any case, the present invention permits the wireless communication device 102 to utilized neighbor list information received from the wireless communication network, such as the server 112, to determine availability of technology types associated with the same network or different networks.

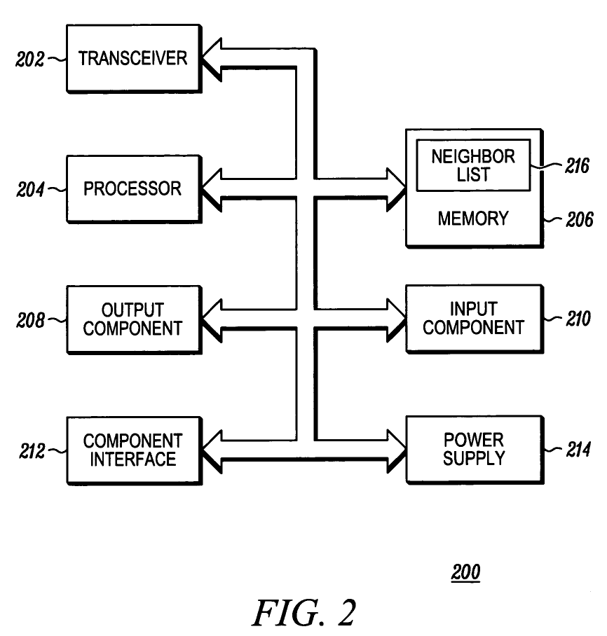

Referring to FIG. 2, there is provided a block diagram representing exemplary internal components 200 that may be utilized by a wireless communication device 102 in accordance with the present invention. The exemplary embodiment includes one or more transceivers 202, a processor 204, a memory component 206, one or more output components 208, and one or more input components 210. The internal components 200 may further include a component interface 212 to provide a direct connection to auxiliary components or accessories for additional or enhanced functionality. The internal components 200 preferably include a power supply 214, such as a battery, for providing power to the other internal components while enabling the wireless communication device 102 to be portable.

The input and output components 208, 210 of the internal components 200 may include a variety of visual, audio and/or mechanical outputs. For example, the visual outputs of the output components 208 may include a liquid crystal display and/or light emitting diode indicators, the audio outputs of the output components may include a speaker, alarm and/or buzzer, and the mechanical outputs of the output components may include a vibrating mechanism. Likewise, by example, the visual inputs of the input components 210 may include an optical sensor (such as a camera), the audio inputs of the input components may includes a microphone, and the mechanical inputs of the input components may include keyboards, keypads, selection buttons, touch pads, touch screens, capacitive sensors, motion sensors, and switches.

The memory component 206 of the internal components 200 may be used by the processor 204 to store and retrieve data. The data that may be stored by the memory component 206 include, but is not limited to, operating systems, applications, and data. Each operating system includes executable code that controls basic functions of the wireless communication device 102, such as interaction among the components of the internal components 200, communication with external devices via the transceiver 202 and/or the component interface 212, and storage and retrieval of applications and data to and from the memory component 206. Each application includes executable code utilizes an operating system to provide more specific functionality for the wireless communication device 102. Data is non-executable code or information that may be referenced and/or manipulated by an operating system or application for performing functions of the wireless communication device 102.

The memory component 206 is configured to store a neighbor list 216 that may be received from the wireless communication network via the transceiver 202. As described below, the neighbor list 216 includes one or more technology type indicators. The wireless communication device 102 may use the neighbor list 216 to determine the availability of technology types associated with a network on which the device is currently registered or otherwise may be directed to register based on a priority level for a given network.

The processor 204 may perform various operations to store, manipulate and retrieve information in the memory component 206. Each component of the internal components 200 is not limited to a single component but represents functions that may be performed by a single component or multiple cooperative components, such as a central processing unit operating in conjunction with a digital signal processor and one or more input/output processors. Likewise, two or more components of the internal components 200 may be combined or integrated so long as the functions of these components may be performed by the communication device.

The wireless communication device 102 may receive broadcast information from the wireless communication network on a regular basis. Examples of broadcast information include, but are not limited to, cell selection information, information for idle mode functions, information needed for access, information for devices in dedicated mode, and/or other information such as cell identity and message scheduling and contents. The cell selection information includes the location area identity and various parameters impacting the access choice, including an indication of whether the call is barred for access. Information for idle mode functions include the configuration of the common channels, the neighbor cells to monitor and the configuration of cell broadcast messages. The information needed for access includes access classes allowed for access, an indication of whether emergency calls are allowed, an indication of whether call reestablishment is allowed, and parameters for controlling the scheduling of access attempts and repetitions. Information for devices in dedicated mode include parameters to control reporting of measurements, a power control indicator, and an indicator of whether a device is obliged, forbidden or permitted to use uplink discontinuous transmission.

The wireless communication device 102 may perform cell reselection, whether it moves through the network or remains stationary. For example, for a cellular communication system such as GSM or GPRS/EDGE, each Base Transceiver Station (BTS) broadcasts a Broadcast Channel Allocation (BA) list on a Broadcast Control Channel (BCCH) or on a Packet Broadcast Control Channel (PBCCH) where a PBCCH is utilized. In this example, the wireless communication device may monitor the BCCH or PBCCH signal strength of the cells indicated by the BA list, i.e., the neighbor list, and sequentially takes at least one radio signal strength indication (RSSI) measurement sample of a neighbor BCCH or PBCCH in every Time Division Multiple Access (TDMA) frame. The mobile station calculates, for each BCCH or PBCCH, a running average of the RSSI samples over a predetermined time period and makes a cell reselection decision based upon these calculated averages.

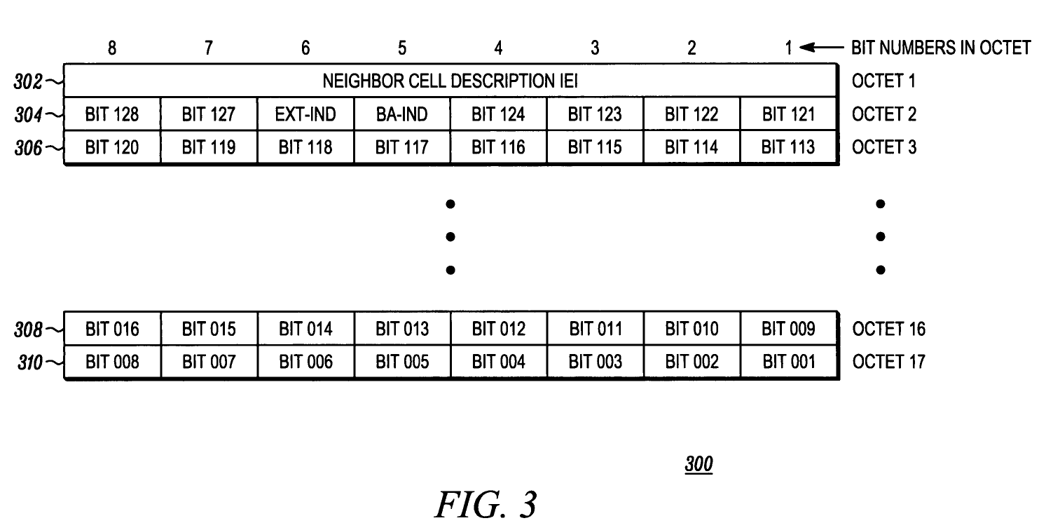

Referring to FIG. 3, there is provided an illustration of an exemplary neighbor list, namely a Neighbor Cell Description element 300 utilized for GSM systems. For this embodiment, the Neighbor Cell Description element 300 is defined as a type 3 information element with a length of 17 octets. Octets 1, 2, 3, 16 and 17 (302, 304, 306, 308, 310, respectively) are shown in FIG. 3. The Neighbor Cell Description element 300 contains a Cell Channel Description element, with the exception of bits 5 and 6 of the second octet 304. Bits 5 and 6 of octet 2 304 correspond to a “BCCH allocation sequence number indication” (BA-IND), and an “Extension Indication” (EXT-IND), respectively.

For the embodiments of the present invention, the neighbor list includes at least one indicator of a technology type and a network identification corresponding to each technology type. The information may be inserted anywhere in the neighbor. For example, for one embodiment, the network identification and technology type indicator are provided at the top of the neighbor list. For example, for a GSM system, the technology type may be a radio access technology (RAT) and the network identification may be a Public Land Mobile Network (PLMN) ID, in which both information are inserted just above or just below the Home PLMN.

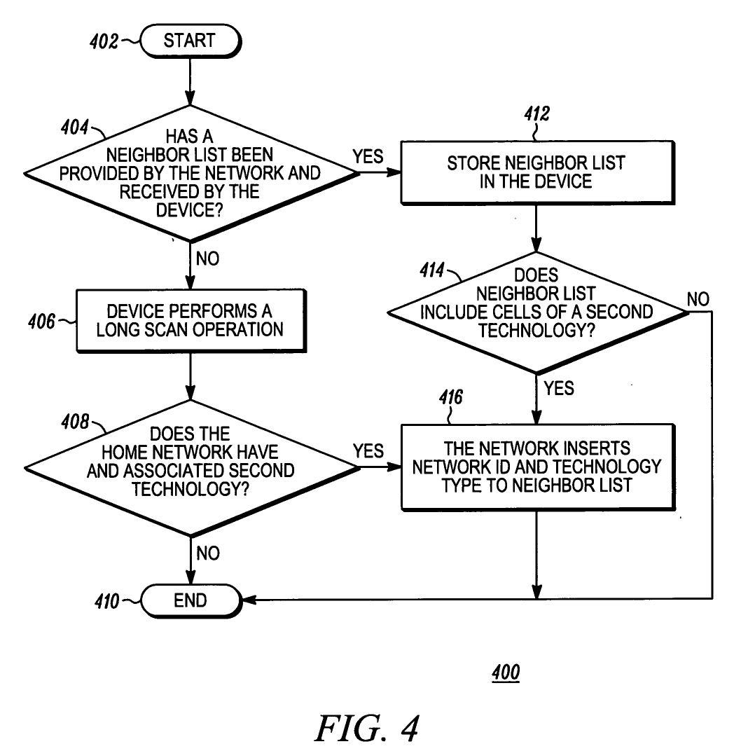

Referring to FIG. 4, there is provided a flow diagram representing a first system operation 400 of the wireless communication network, including the base stations 108, 110 and the server 112, and the wireless communication device 102 in accordance with the present invention. The first system operation 400 occurs each time a triggering event occurs, such as a periodic timer expires. After starting the first system operation 400 at step 402, the wireless communication device 102 determines whether the network (such as the server 112) has provided a neighbor list at step 404. If a neighbor list has not been received from the network, the device 102 performs a long scan operation at step 406. The device 102 then determines whether the Home Network has an associated second technology. For one embodiment, the device 102 determines whether the Home PLMN has an associated RAT. If not, then the first system operation 400 terminates at step 410. On the other hand, if the device 102 determines that the Home Network has an associated second technology, then the network (such as server 112) inserts a network ID and a technology type, or any other identifier, to the neighbor list at step 416 before the first system operation 400 terminates at step 410. As described above, the identifier or identifiers may be inserted at the top of the neighbor list.

Referring back to step 404, if a neighbor list has been received from the network, then the device 102 stores the neighbor list 216 in its memory component 206 at step 412. Next, the device 102 determines whether the neighbor list includes cells of a second technology, such as UMTS cells, or other means of impacting the priority of the list elements, such as RAT, at step 414. If not, the first system operation 400 terminates at step 410. If, however, the device 102 determines that the neighbor list includes cells of a second technology, then the network (such as server 112) inserts a network ID and a technology type, or any other identifier, to the neighbor list at step 416 before the first system operation 400 terminates at step 410.

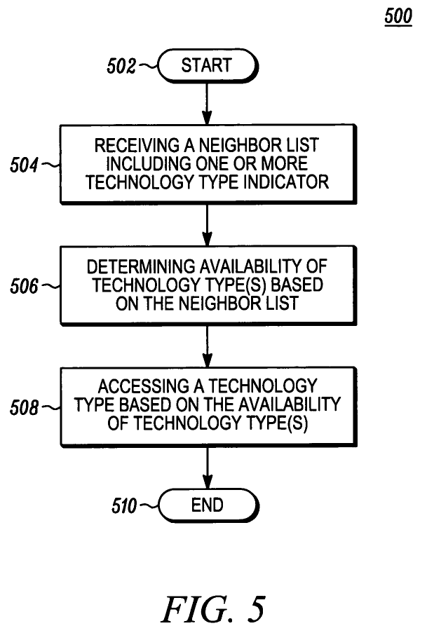

Referring to FIG. 5, there is provided a flow diagram representing a device operation 500 of the wireless communication device 102 in accordance with the present invention. The device operation 500 occurs each time a neighbor list is received from the wireless communication network after the network has inserted technology type information to the neighbor list. After starting at step 502, the device 102 receives a neighbor list that includes one or more technology type indicator at step 504. Next, the device 102 determines availability of one or more technology types based on the neighbor list or, more particularly, the technology type indicator at step 506. The device 102 then accesses a particular technology type based on the availability of the technology types at step 508, and terminates the device operation 500 at step 510.

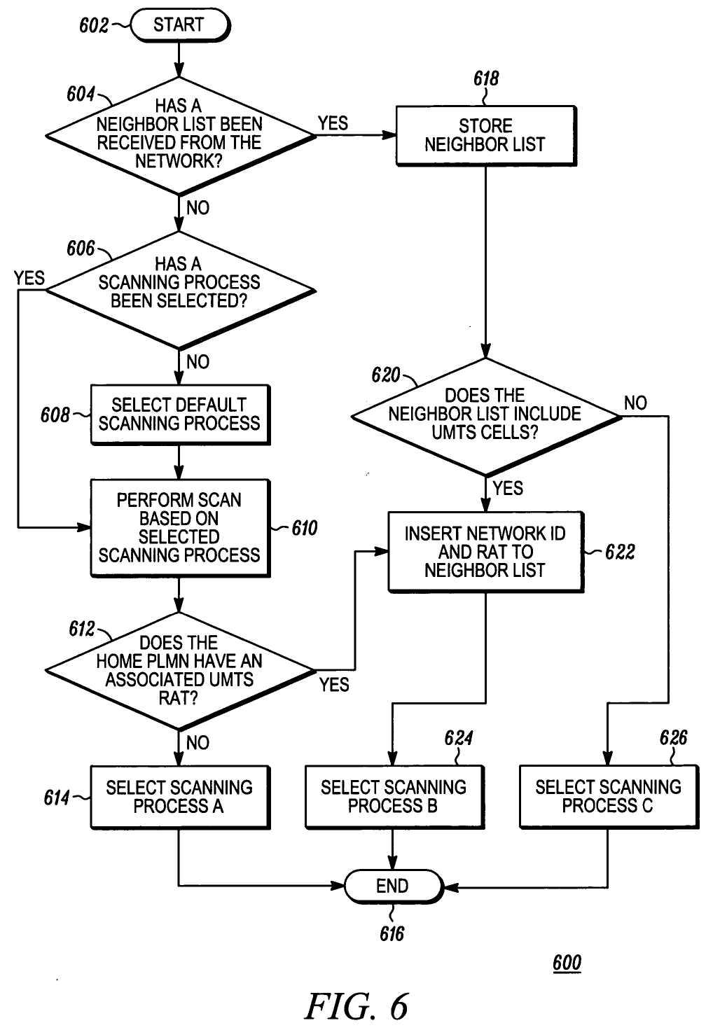

Referring to FIG. 6, there is provided a flow diagram representing a second system operation 600 of the wireless communication network and the wireless communication device 102, which is an alternative to the first system operation 400 described above. Although the second system operation 600 specifies elements of a GSM system, such as a Home PLMN and UMTS RAT/cells, it is to be understood that the operation may generally apply to interaction with various types of cellular and WLAN systems as specified above. Similar to the first system operation 400, the second system operation 600 occurs each time a triggering event occurs, such as a periodic timer expires.

After starting the second system operation 600 at step 602, the wireless communication device 102 determines whether the network (such as the server 112) has provided a neighbor list at step 604. If a neighbor list has not been received from the network, then the device 102 checks its memory component 206 to see if a scanning process has been selected at step 606. If a scanning process has not been selected, then the device 102 selects a default scanning process at step 608 and performs a scan based on the default scanning process at step 610. Otherwise, if a scanning process has been selected, then the device 102 performs a scan based on the selected scanning process at step 610.

In either case, the device 102 determines whether the Home Network, e.g., Home PLMN, has an associated second technology, e.g., UMTS RAT, at step 612. If not, then the device 102 (or the network) selects a first scanning process, i.e., scanning process A, at step 614, and terminates at step 616. On the other hand, if the device 102 determines that the Home Network has an associated second technology, then the network (such as server 112) inserts a network ID and a technology type, or any other identifier, e.g., RAT, to the neighbor list at step 622 before the device (or the network) selects a second scanning process at step 624 and the second system operation 600 terminates at step 616. As described above, the identifier or identifiers may be inserted at the top of the neighbor list. The second scanning process, i.e., scanning process B, of step 624 is preferably different from the first scanning process of step 614.

Referring back to step 604, if a neighbor list has been received from the network, then the device 102 stores the neighbor list 216 in its memory component 206 at step 618. Next, the device 102 determines whether the neighbor list includes cells of a second technology, such as UMTS cells, or other means of impacting the priority of the list elements, such as RAT, at step 620. If not, then the device 102 selects a third scanning process, i.e., scanning process C, at step 626 and the second system operation 600 terminates at step 616. If, however, the device 102 determines that the neighbor list includes cells of a second technology, then the network (such as server 112) inserts a network ID and a technology type, or any other identifier, to the neighbor list at step 622 before the device or the network selects the second scanning process at step 624 and the second system operation 600 terminates at step 616. The third scanning process, i.e., scanning process C, of step 626 is preferably different from the first scanning process of step 614 and the second scanning process of step 624.

The scanning processes that may be selected at steps 614, 624, 626 and may be used to control how and when the device 102 performs its scan at step 610. For example, the default scanning algorithm of step 608 may be “scan 2G/3G and any other RAT, and set periodic timer short”; the first scanning process of step 614 may be “scan 2G only and set periodic timer short”; the second scanning process of step 624 may be “set periodic timer long”; and the third scanning process of step 626 may be “set periodic timer short”. Accordingly, the scanning process of the device 102 is selected based on the device's current system and/or the contents of the neighbor list as most-recently received from the network.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

1. A method for a wireless communication device comprising:
receiving a neighbor list including at least one technology type indicator; and
determining availability of technology based on the neighbor list.

2. The method of claim 1, wherein determining availability of technology includes determining availability of technology associated with a network on which the wireless communication device is currently registered or directed to register based on a priority level for a given network.

3. The method of claim 1, wherein determining availability of technology includes determining availability of at least one radio access technology of a wideband cellular network.

4. The method of claim 1, wherein determining availability of technology includes determining availability of at least one radio access technology of a wireless local area network.

5. The method of claim 1, further comprising accessing a technology type based on the availability of technology.

6. The method of claim 5, further comprising registering with a Public Land Mobile Network (PLMN) in response to determining availability of at least one radio access technology associated with the PLMN.

7. The method of claim 1, further comprising selecting a scanning process based on the availability of technology.

8. The method of claim 1, wherein receiving a neighbor list including at least one technology type indicator includes receiving the neighbor list including a first radio access technology and a second radio access technology having a wider bandwidth capability that the first radio access technology.

9. The method of claim 1, wherein receiving a neighbor list including at least one technology type indicator includes receiving the neighbor list including a first radio access technology for cellular-based communication and a second radio access technology for wireless local area network communication.

10. The method of claim 1, further comprising storing the neighbor list in the wireless communication device.

11. A wireless communication device comprising:
a transceiver configured to receive a neighbor list from a remote source, the neighbor list including at least one technology type indicator.

12. The wireless communication device of claim 11, further comprising a processor configured to determine availability of technology based on the neighbor list.

13. The wireless communication device of claim 12, wherein the processor determines availability of technology associated with a network on which the wireless communication device is currently registered or directed to register based on a priority level for a given network.

14. The wireless communication device of claim 12, wherein the processor determines availability of at least one radio access technology of a wideband cellular network.

15. The wireless communication device of claim 12, wherein the processor determines availability of at least one radio access technology of a wireless local area network.

16. The wireless communication device of claim 12, wherein the transceiver registers with a Public Land Mobile Network (PLMN) in response to determining availability of at least one radio access technology associated with the PLMN.

17. The wireless communication device of claim 12, wherein the processor selects a scanning process based on the availability of technology.

18. The wireless communication device of claim 11, wherein the neighbor list includes a first radio access technology and a second radio access technology having a wider bandwidth capability that the first radio access technology.

19. The wireless communication device of claim 11, wherein the neighbor list includes a first radio access technology for cellular-based communication and a second radio access technology for wireless local area network communication.

20. The wireless communication device of claim 11, further comprising a memory configured to store the neighbor list.

21. A method for a wireless communication network comprising:
inserting network identification and technology type to a neighbor list; and
providing the neighbor list to a remote device.

22. The method of claim 21, further comprising determining whether a home network of the remote device is associated with at least two technology types.

23. The method of claim 22, wherein inserting network identification and technology type to a neighbor list occurs in response to determining that the home network of the remote device is associated with at least two technology types.

24. The method of claim 22, wherein determining whether a home network of the remote device is associated with at least two technology types occurs after determining that a usable neighbor list has not been provided to the remote device.

25. The method of claim 21, wherein inserting network identification and technology type to a neighbor list occurs after determining that a usable neighbor list has not be provided to the remote device.

26. A wireless communication network comprising:
a server configured to insert network identification and technology type to a neighbor list; and
a base station, communicating with the server, configured to provide the neighbor list to a remote device.

27. The wireless communication network of claim 26, wherein the server determines whether a home network of the remote device is associated with at least two technology types.

28. The wireless communication network of claim 27, wherein the server inserts the network identification and the technology type to the neighbor list in response to determining that the home network of the remote device is associated with at least two technology types.

29. The wireless communication network of claim 27, wherein the server determines whether a home network of the remote device is associated with at least two technology types after determining that a usable neighbor list has not been provided to the remote device.

30. The wireless communication network of claim 26, wherein the server inserts the network identification and the technology type to the neighbor list after determining that a usable neighbor list has not be provided to the remote device.
